(19) United States
(12) Patent Application Publication
(10) Pub. No.: US 2025/0389823 A1
(43) Pub. Date: Dec. 25, 2025

(54) LASER DISTANCE MEASUREMENT DEVICE, LASER DISTANCE MEASUREMENT METHOD, AND PROGRAM

(71) Applicant: FUJIFILM Corporation, Tokyo (JP)

(72) Inventor: Yuya ISHIZUKA, Kanagawa (JP)

(73) Assignee: FUJIFILM Corporation, Tokyo (JP)

(21) Appl. No.: 19/304,546

(22) Filed: Aug. 19, 2025

Related U.S. Application Data
(63) Continuation of application No. PCT/JP2024/003471, filed on Feb. 2, 2024.

(30) Foreign Application Priority Data
Feb. 24, 2023 (JP) 2023-027050

(51) Int. Cl. G01S 7/4865; G01B 11/24; G01S 7/4911; G01S 17/10; G01S 17/32

(52) U.S. Cl. CPC G01S 7/4865; G01B 11/24; G01S 7/4911; G01S 17/10; G01S 17/32

(57) ABSTRACT

Provided are a miniaturized laser distance measurement device, a laser distance measurement method, and a program that can perform measurement robust to a change in a distance to a measurement object. A laser distance measurement device includes a laser light source that emits first laser light of an FMCW method, an intensity modulator that periodically modulates an intensity of the first laser light to generate pulsed second laser light, a first distance measurement instrument (F4) that detects a beat frequency included in interference light and that acquires first distance information to a measurement object based on the beat frequency, and a second distance measurement instrument (F5) that measures a round-trip time of a pulse component to the measurement object and that acquires second distance information to the measurement object based on the round-trip time.

### CROSS-REFERENCE TO RELATED APPLICATIONS

The present application is a Continuation of PCT International Application No. PCT/JP2024/003471 filed on Feb. 2, 2024 claiming priority under 35 U.S.C § 119(a) to Japanese Patent Application No. 2023-027050 filed on Feb. 24, 2023. Each of the above applications is hereby expressly incorporated by reference, in its entirety, into the present application.

### BACKGROUND OF THE INVENTION

### 1. Field of the Invention

The present invention relates to a laser distance measurement device, a laser distance measurement method, and a program.

### 2. Description of the Related Art

In recent years, inspection of structural damage or aging deterioration has been performed by measuring a shape of the structure using light detection and ranging (LiDAR). Here, LiDAR employs various schemes depending on the distance measurement principle. For example, a time-of-flight (ToF) LiDAR and a frequency-modulated continuous wave (FMCW) LiDAR are known.

JP2017-524918A describes a ToF LiDAR and an FMCW LiDAR.

### SUMMARY OF THE INVENTION

Here, an attempt has been made to detect a defect referred to as delamination by measuring the shape of the structure such as a bridge or a tunnel with the LiDAR. Here, the delamination refers to a state in which cracking inside the concrete is continuous or defects at the time of construction are continuous due to vibration or deformation during use, and the concrete near the surface of the structure is losing integrity with the internal concrete. In concrete in which delamination occurs, in a case in which deterioration further progresses or a shock is applied, peeling occurs. Therefore, it is important to detect the delamination as a damaged portion through the inspection.

In order to detect the delamination with the LiDAR, it is necessary to measure the uneven shape of the surface of the structure of the order of 0.1 mm, and it is necessary to use a LiDAR with high measurement accuracy.

Meanwhile, the structure as the measurement object has diverse shapes, and the distance from the laser distance measurement device to the structure is not always constant. Depending on the shape of the structure, the distance from the laser distance measurement device to the structure may be changed rapidly. Furthermore, LiDARs having high measurement accuracy require precise focusing of the light from the light source on the surface of the measurement object to maintain adequate S/N ratio, which limits the distance measurable range.

Therefore, in a case in which the shape of the structure changes and the structure falls outside the measurable range of the LiDAR, there is a case in which the measurement cannot be performed.

In order to perform the focus adjustment of the LiDAR with high measurement accuracy, it is also conceivable to provide a separate distance measurement device and perform the focus adjustment of the LiDAR with high measurement accuracy based on distance information obtained by the separate distance measurement device. However, in a case in which the distance measurement device for focus adjustment is provided as a separate body, the device itself is increased in size, and it becomes difficult to measure a small-diameter tunnel, or the mobility is deteriorated.

The present invention has been made in view of such circumstances, and an object of the present invention is to provide a miniaturized laser distance measurement device, a laser distance measurement method, and a program that can perform accurate measurement that is robust to a change in distance to a measurement object.

In order to achieve the above-described object, a first aspect of the present invention provides a laser distance measurement device comprising: a laser light source that emits first laser light of a frequency-modulated continuous wave (FMCW) mode; an intensity modulator that periodically modulates an intensity of the first laser light to generate pulsed second laser light; a first distance measurement instrument that generates an interference light by incidence of first measurement light obtained from the second laser light and first reference light obtained from the first laser light, that detects a beat frequency included in the interference light, and that acquires first distance information to a measurement object based on the beat frequency; and a second distance measurement instrument that measures a round-trip time of a pulse component included in the first measurement light to the measurement object based on information regarding an emission timing of the second laser light from the intensity modulator and the pulse component, and that acquires second distance information to the measurement object based on the round-trip time.

A second aspect provides the laser distance measurement device according to the first aspect, in which it is preferable that the laser distance measurement device further comprises: a processor configured to, in a case in which the first distance information and the second distance information are acquired, determine the first distance information as third distance information to be output.

A third aspect provides the laser distance measurement device according to the second aspect, in which it is preferable that the processor is configured to, in a case in which the first distance information and the second distance information are acquired, store the first distance information in a memory as the third distance information.

A fourth aspect provides the laser distance measurement device according to the first aspect, in which it is preferable that the laser distance measurement device further comprises: a beam splitter that splits the first reference light from the first laser light.

A fifth aspect provides the laser distance measurement device according to the first aspect, in which it is preferable that the laser distance measurement device further comprises: a beam splitter that splits the first measurement light reflected by the measurement object into second measurement light and third measurement light, and the second measurement light is incident on the first distance measurement instrument, and the third measurement light is incident on the second distance measurement instrument.

A sixth aspect provides the laser distance measurement device according to the first aspect, in which it is preferable that the laser distance measurement device further comprises: a focus adjustment mechanism that adjusts a focus position of the first measurement light and that focuses the first measurement light on a surface of the measurement object; and a processor configured to control the focus adjustment mechanism based on the second distance information.

A seventh aspect provides the laser distance measurement device according to the first aspect, in which it is preferable that the intensity modulator is configured as an acousto-optic element, an LN modulator, or an optical switch.

An eighth aspect provides the laser distance measurement device according to the first aspect, in which it is preferable that the information regarding the emission timing is information regarding an emission timing of the pulse component of the second laser light.

A ninth aspect provides a laser distance measurement method comprising: a step of, via a laser light source, emitting first laser light of a frequency-modulated continuous wave (FMCW) mode; a step of, via an intensity modulator, periodically modulating an intensity of the first laser light to generate pulsed second laser light; a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.

A tenth aspect provides a program causing a computer to execute: a step of, via a laser light source, emitting first laser light of a frequency-modulated continuous wave (FMCW) mode; a step of, via an intensity modulator, periodically modulating an intensity of the first laser light to generate pulsed second laser light; a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.

According to the aspects of the present invention, since the distance is measured by the first distance measurement instrument having relatively high accuracy and the second distance measurement instrument having relatively high sensitivity with the measurement light emitted from the same laser light source, it is possible to perform measurement that has high measurement accuracy and that is robust to the change in the distance to the measurement object, by using the miniaturized device.

### BRIEF DESCRIPTION OF THE DRAWINGS

FIG. 1 is a conceptual diagram showing an inspection apparatus comprising a laser distance measurement device.

FIG. 2 is a conceptual diagram showing functional blocks and laser light in a measurement head.

FIG. 3 is a diagram showing a specific configuration example of the measurement head.

FIG. 4 is a block diagram showing a hardware configuration example of a control device.

FIG. 5 is a block diagram showing main functions implemented by a processor.

FIG. 6 is a flowchart showing a laser distance measurement method.

FIG. 7 is a diagram showing a beat signal.

FIGS. 8A and 8B are diagrams showing a beat signal.

FIG. 9 is a diagram showing a storage configuration example of table data.

### DESCRIPTION OF THE PREFERRED EMBODIMENTS

Hereinafter, preferred embodiments of a laser distance measurement device, a laser distance measurement method, and a program according to the embodiment of the present invention will be described with reference to the accompanying drawings.

### Inspection Apparatus

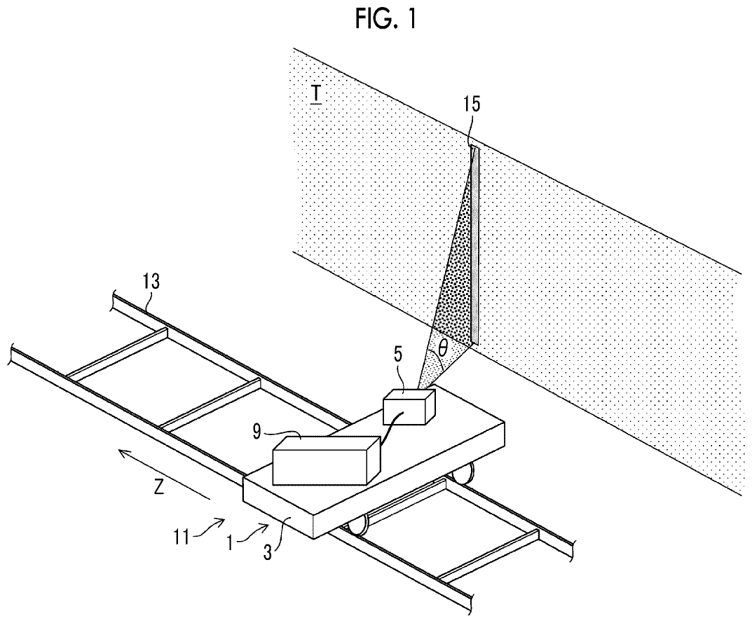

FIG. 1 is a conceptual diagram showing an inspection apparatus comprising the laser distance measurement device that is one embodiment of the present invention.

An inspection apparatus 11 measures a three-dimensional shape of a structure, which is a measurement object, by a laser distance measurement device 1. Then, damage, such as delamination, is detected based on the obtained three-dimensional shape. Hereinafter, the distance measurement for obtaining the three-dimensional shape will be mainly described, and the description of the detection of the damage and the like will be omitted.

The laser distance measurement device 1 comprises a measurement head 5 and a control device 9. The laser distance measurement device 1 is mounted on a cart 3. The cart 3 travels on a railroad 13 in a positive Z-axis direction. Then, the laser distance measurement device 1 mounted in the cart 3 acquires a distance to an inner wall surface T (hereinafter simply referred to as a wall surface T) of the structure (tunnel) that is the measurement object. In this way, by acquiring the distance to the wall surface T with the laser distance measurement device 1 and acquiring the three-dimensional shape of the wall surface T, and the damage (for example, delamination) can be detected. It should be noted that, in the following example, a concrete tunnel will be described as a specific example of the structure, but the measurement object as the measurement object to which the present invention is applied is not limited thereto. For example, a metal member, a plastic member, or the like can also be used as the measurement object according to the embodiment of the present invention.

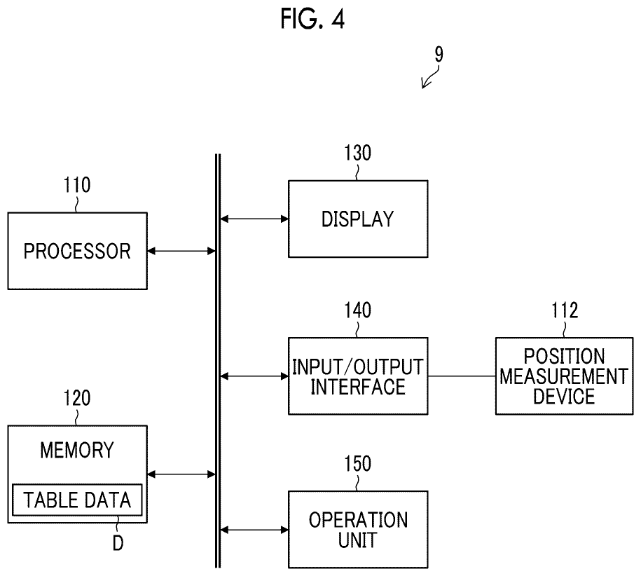

Positional information of the measurement head 5 is acquired by a position measurement device 112 (not shown in FIG. 1, see FIG. 4).

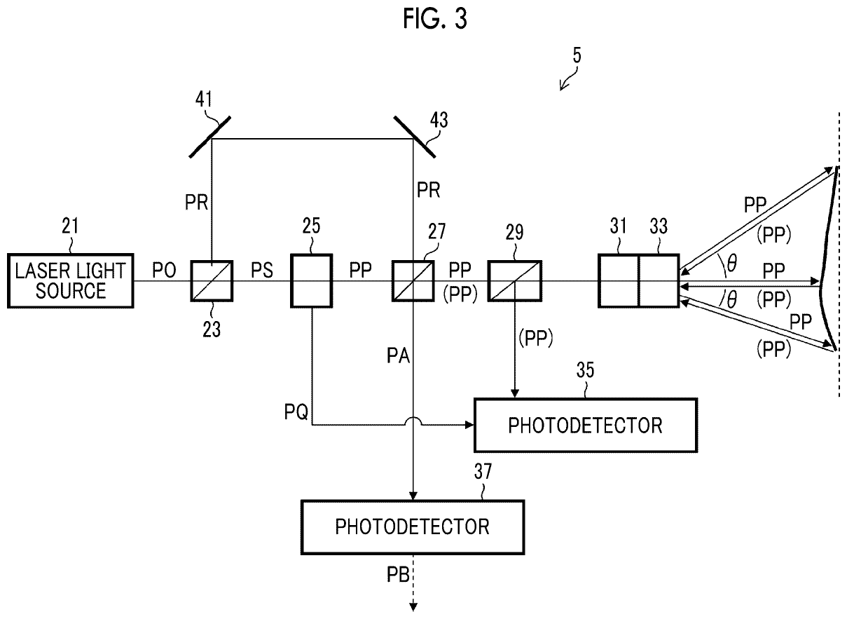

In addition, FIG. 1 shows a scanning line 15 of the measurement head 5 at a position of a certain cart 3. As described above, in the measurement head 5, a scanning unit (scanner) 33 (see FIG. 3) sequentially changes a scanning angle (irradiation angle) θ, and scans the wall surface T to measure the distances at a plurality of measurement points.

Here, the laser distance measurement device 1 can perform FMCW-method measurement and ToF-method measurement with one measurement head 5 as described below. Therefore, in a state in which the focus position is aligned with the wall surface T which is the measurement object, it is possible to perform highly accurate measurement by the FMCW-method measurement, and even in a case in which the focus position is not aligned with the measurement object, it is possible to perform highly sensitive measurement by the ToF-method measurement. In addition, the FMCW-method measurement and the ToF-method measurement can be performed by one measurement head 5. Hereinafter, a case will be described in which the three-dimensional shape of the wall surface T is acquired by the distance acquired by the laser distance measurement device 1.

The control device 9 of the laser distance measurement device 1 calculates the distance from the measurement head 5 to the measurement point on each scanning line of the laser light emitted from the measurement head 5. Then, the control device 9 measures the distance of laser light emitted from the scanning unit 33 to a large number of measurement points on each scanning line (that is, on the wall surface T), to acquire three-dimensional measurement data of a polar coordinate system consisting of an irradiation direction of the laser light and a measurement distance (three-dimensional measurement data of the polar coordinate system indicating the surface shape of the wall surface T). The control device 9 acquires the three-dimensional measurement data (three-dimensional shape) indicating the shape of the wall surface T by converting the three-dimensional measurement data of the polar coordinate system into three-dimensional data of an orthogonal coordinate system.

Further, by calculating the distance (height from a reference surface) in a normal direction of the three-dimensional measurement data with respect to a defined reference surface of the wall surface T, an amount of bulging (amount of delamination) of the wall surface T can be detected. As described above, the delamination can be detected with high accuracy by the distance acquired by the laser distance measurement device 1.

Three-dimensional measurement data (point cloud data) of a large number of measurement points on the wall surface T is acquired as the three-dimensional measurement data measured by the laser distance measurement device 1 according to the present example as described above, but it is considered to perform the following conditions in order to measure the minute uneven shape of the wall surface T.
Measurement accuracy: 50 μm
Measurement distance: 2 m to 7 m
Measurement speed: 10 m²/sec in terms of area (speed of laser light is equivalent to 4000 rpm)

It should be noted that the scanning unit 33 of the measurement head 5 continuously emits the laser light in which the frequency of the laser light is frequency-modulated for a certain period of time.

### Laser Distance Measurement Device

Hereinafter, the measurement head 5 of the laser distance measurement device 1 will be described.

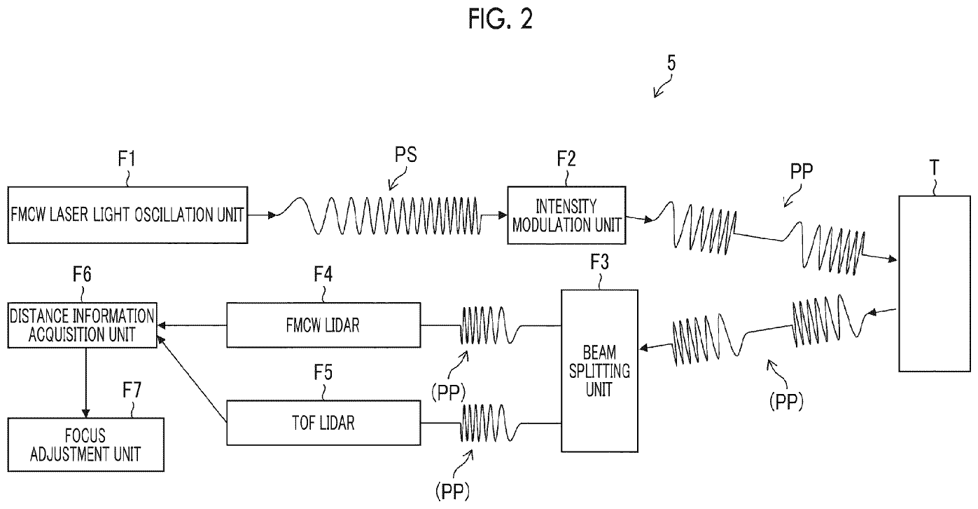

FIG. 2 is a conceptual diagram showing a functional blocks and the laser light in the measurement head 5.

The measurement head 5 mainly has functions of an FMCW laser oscillation unit F1, an intensity modulation unit F2, a beam splitting unit F3, an FMCW LiDAR F4, a ToF LiDAR F5, and a distance information acquisition unit F6.

First laser light for measurement PS (first laser light) emitted from the FMCW laser oscillation unit F1 is incident on the intensity modulation unit F2. In the intensity modulation unit F2, the first laser light for measurement PS is pulsed by periodically intensity-modulating the first laser light for measurement PS, and pulsed second laser light for measurement PP (second laser light, first measurement light) is emitted to the wall surface T. The second laser light for measurement (PP) reflected by the wall surface T is split by the beam splitting unit F3. The one split second laser light for measurement (PP) (second measurement light) is incident on the FMCW LiDAR F4 (first distance measurement instrument), and the distance information is acquired by the distance information acquisition unit F6. In addition, the other split second laser light for measurement (PP) (third measurement light) is incident on the ToF LiDAR F5 (second distance measurement instrument), and the distance information is acquired by the distance information acquisition unit F6. In addition, the focus of the second laser light for measurement PP is adjusted to be on a measurement surface in a focus adjustment unit F7 based on the distance information acquired by the distance information acquisition unit F6.

As described above, in the measurement head 5, the distance information is acquired by the FMCW LiDAR F4 that can perform the distance measurement with high accuracy in a case in which the focus position is aligned with the wall surface T and the ToF LiDAR F5 that can perform the distance measurement with high sensitivity in a wide range of the measurement distance, so that it is possible to perform accurate measurement that is robust to the change in the measurement distance. In addition, in the measurement head 5, the measurement light from one FMCW laser oscillation unit F1 is split by the beam splitting unit F3, and the distance measurement is performed by the FMCW LiDAR F4 and the ToF LiDAR F5, so that the distance measurement can be performed by a miniaturized device.

FIG. 3 is a diagram showing a specific configuration example of the measurement head 5. It should be noted that the measurement head 5 is integrally controlled by the control device 9 (FIG. 4).

The measurement head 5 is composed of a laser light source 21 of an FMCW type, a first beam splitter 23, an intensity modulator 25, a second beam splitter 27, a third beam splitter 29, a focus adjustment mechanism 31, a scanning unit 33, a photodetector 35, a photodetector 37, and reference mirrors 41 and 43. The measurement head 5 has functions of an FMCW distance measurement instrument (first distance measurement instrument) and a ToF distance measurement instrument (second distance measurement instrument) with the above configuration. Hereinafter, each of the FMCW distance measurement instrument and the ToF distance measurement instrument will be described.

### FMCW LiDAR

The FMCW LiDAR F4 will be described. The FMCW LiDAR F4 can measure the distance to the measurement object with high accuracy. However, in order to perform the measurement with the FMCW LiDAR F4, it is necessary to focus on the measurement object with high accuracy. It should be noted that, as the FMCW LiDAR F4, a LiDAR using a frequency-shifted feedback laser (FSF laser) that is a type of FMCW LiDAR F4 is suitably used.

The FMCW LiDAR F4 is composed of the laser light source 21, the first beam splitter 23, the intensity modulator 25, the second beam splitter 27, the third beam splitter 29, the focus adjustment mechanism 31, the scanning unit 33, the reference mirrors 41 and 43, and the photodetector 37.

The laser light source 21 constitutes the FMCW laser oscillation unit F1. The laser light source 21 may, for example, be an FSF laser that oscillates by inserting an acousto-optic modulator (AOM), which is a frequency-shifting element, into the resonator and feeding back the first-order diffracted light whose frequency has been shifted by the AOM.

First laser light PO emitted from the laser light source 21 is split into the first laser light for measurement PS and laser light for reference PR by the first beam splitter 23. The laser light for reference PR is reflected by the reference mirrors 41 and 43, and is incident on the second beam splitter 27. Meanwhile, the first laser light for measurement PS is incident on the intensity modulator 25. It should be noted that the laser light for reference PR is not input to the intensity modulator 25. This is because, in a case in which the laser light for reference PR is intensity-modulated, there is no guarantee that the reflected light reflected by the wall surface T temporally overlaps with the laser light for reference PR, and a case in which the beat frequency cannot be detected in the photodetector 37 occurs.

The intensity modulator 25 constitutes the intensity modulation unit F2. The intensity modulator 25 periodically modulates the intensity of the first laser light for measurement PS, to emit the pulsed second laser light for measurement PP. Here, the intensity modulator 25 is specifically configured as an acousto-optic modulator (AOM), an LN modulator, or an optical switch.

The second laser light for measurement PP is transmitted through the second beam splitter 27 and the third beam splitter 29, and is incident on the focus adjustment mechanism 31. The focus adjustment mechanism 31 has a function of adjusting the focus position of the second laser light for measurement PP and focusing the laser light for measurement on the surface of the measurement object. For example, the focus adjustment mechanism 31 adjusts the focus position of the second laser light for measurement PP by moving a focus lens along the optical axis direction. It should be noted that a moving amount of the focus adjustment mechanism 31 is input from the control device 9 as a focus operation amount. In addition, a specific aspect of the focus adjustment mechanism 31 is not limited to the adjustment of the focus position by the movement of the focus lens in the optical axis direction. For example, the focus position may be changed by changing a curvature of a spherical surface of a lens by a liquid lens.

The second laser light for measurement PP passes through the focus adjustment mechanism 31, and is then incident on the scanning unit 33. The scanning unit 33 changes an emission direction of the second laser light for measurement PP and performs the scanning and the distance measurement. For example, the scanning unit 33 sequentially irradiates the scanning line 15 (FIG. 1) of the wall surface T with the second laser light for measurement PP. The scanning unit 33 is composed of, for example, a polygon mirror and a motor that rotates the polygon mirror, and laser light for measurement is incident on the polygon mirror. The scanning unit 33 rotates the polygon mirror in a direction around a first axis by a motor to rotate (turn) the laser light for measurement reflected by the polygon mirror. As a result, the surface of the wall surface T is scanned with the second laser light for measurement PP. Further, a rotation speed of the polygon mirror in the direction of the first axis can be, for example, 4000 rpm.

The second laser light for measurement (signal light) (PP) reflected by the surface of the wall surface T is incident on the scanning unit 33 as the reflected light. Then, the second laser light for measurement (PP) passes through the focus adjustment mechanism 31, and is incident on the third beam splitter 29. Here, the third beam splitter 29 constitutes the beam splitting unit F3.

The second laser light for measurement (PP) incident on the third beam splitter 29 is split into light incident on the second beam splitter 27 and light incident on the photodetector 35 for calculating a time of flight.

The second laser light for measurement (PP) incident on the second beam splitter 27 is combined with the laser light for reference PR by the second beam splitter 27, and is output as the interference light PA.

The photodetector 37 performs photoelectric conversion on the interference light PA output from the second beam splitter 27, and detects a beat signal PB (interference signal) indicating the interference light PA. The beat signal PB detected by the photodetector 37 is input to an FMCW LiDAR processing unit 110B of the control device 9. Then, the FMCW LiDAR processing unit 110B acquires the distance to the wall surface T based on the beat signal PB. As described above, the measurement head 5 can measure the distance to the wall surface T by the FMCW LiDAR F4.

### ToF LiDAR

Next, the ToF LiDAR F5 provided in the measurement head 5 will be described.

The measurement distance range of the ToF LiDAR F5 is longer than the measurement distance range of the FMCW LiDAR F4, and the measurement accuracy is lower than the measurement accuracy of the FMCW LiDAR F4. For example, the measurement distance range of the ToF LiDAR F5 is 1 m to 100 m, whereas the measurement distance range of the FMCW LiDAR F4 is 1 m to 1.5 m or 2 m to 3 m. Therefore, the ToF LiDAR F5 can perform the distance measurement with high sensitivity and can perform the alternative measurement in a case in which the focus cannot be aligned and the distance cannot be measured well in the FMCW LiDAR F4. The ToF LiDAR F5 is composed of the laser light source 21, the intensity modulator 25, the third beam splitter 29, the focus adjustment mechanism 31, the scanning unit 33, and the photodetector 35.

As described above, the laser light source 21 is an FSF laser, and the first laser light PO emitted from the laser light source 21 is split into the first laser light for measurement PS and the laser light for reference PR by the first beam splitter 23. Then, the first laser light for measurement PS is incident on the intensity modulator 25. The intensity modulator 25 emits the pulsed second laser light for measurement PP by allowing the first laser light for measurement PS to be incident thereon and periodically modulating the intensity thereof. The second laser light for measurement PP is transmitted through the second beam splitter 27, the third beam splitter 29, and the focus adjustment mechanism 31, and is input to the scanning unit 33. The scanning unit 33 changes the emission direction of the second laser light for measurement PP under the control of the control device 9. The scanning unit 33 sequentially irradiates the scanning line 15 (FIG. 1) of the wall surface T with the laser light P. In addition, the scanning unit 33 receives the second laser light for measurement (PP) that is the reflected light of the emitted laser light reflected by the wall surface T. Thereafter, the second laser light for measurement (PP) is split by the third beam splitter 29, and is detected by the photodetector 35.

The photodetector 35 detects the second laser light for measurement (PP), and outputs a detection signal. In addition, the photodetector 35 receives a radio frequency (RF) signal PQ from the intensity modulator 25 to acquire information regarding an emission timing of a pulse component in the second laser light for measurement PP.

A ToF LiDAR processing unit 110C (FIG. 4) implemented by a processor 110 in the control device 9 processes the detection signal output from the photodetector 35 by executing a program stored in a memory 120. Specifically, the ToF LiDAR processing unit 110C outputs the distance to the wall surface T based on the information regarding the emission timing obtained from the RF signal PQ and the detection signal indicating the intensity of the light received by the photodetector 35. As described above, the measurement head 5 can measure the distance to the wall surface T by the ToF LiDAR F5.

### Control Device

Hereinafter, the control device 9 will be described. The control device 9 is configured by, for example, a computer or a microcomputer. The control device 9 controls the measurement head 5 to implement the measurement of the distance to the wall surface T.

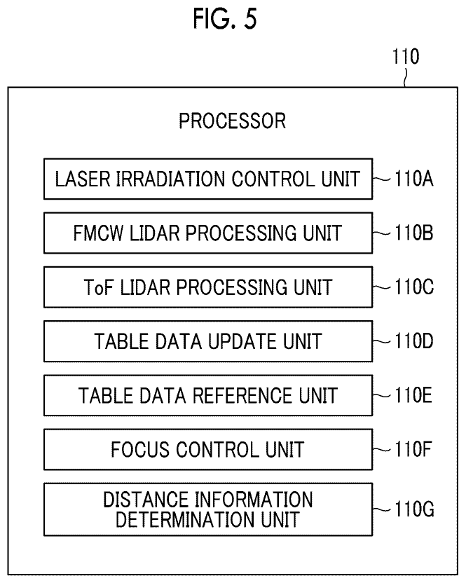

FIG. 4 is a block diagram showing a hardware configuration example of the control device 9. In addition, FIG. 5 is a block diagram showing main functions implemented by the processor 110. It should be noted that the processor 110 achieves the functions shown in FIG. 5 by executing a dedicated program stored in the memory 120.

The control device 9 comprises the processor 110, the memory 120, a display 130, an input/output interface 140, and an operation unit 150.

The processor 110 is configured with a central processing unit (CPU) or the like, and integrally controls the respective units of the control device 9 and performs control of the distance measurement of the laser distance measurement device 1. As shown in FIG. 5, the processor 110 is composed of a laser irradiation control unit 110A, the FMCW LiDAR processing unit 110B, the ToF LiDAR processing unit 110C, a table data update unit 110D, a table data reference unit 110E, a focus control unit 110F, and a distance information determination unit 110G.

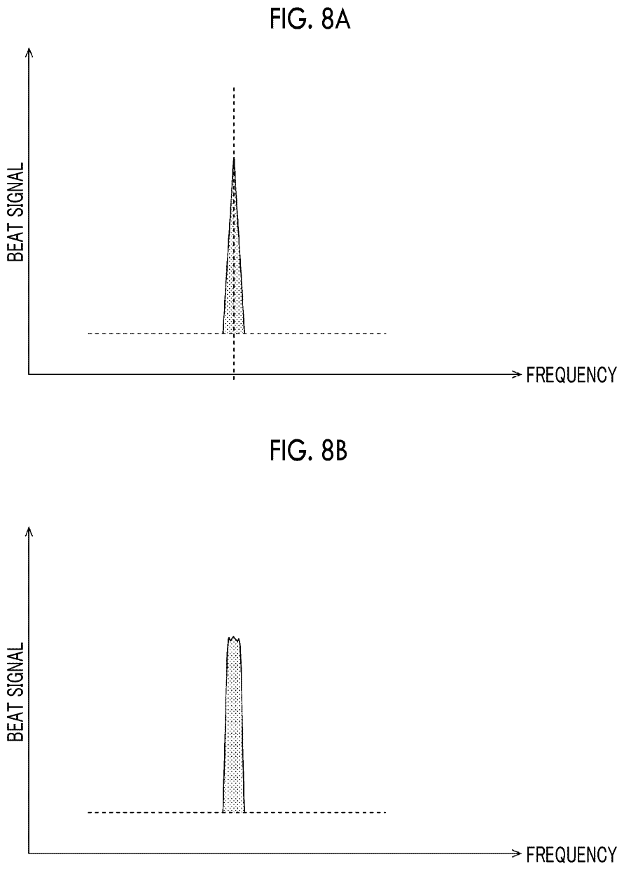

The memory 120 includes a flash memory, a read-only memory (ROM), a random-access memory (RAM), a hard-disk drive, and the like. The flash memory, the ROM, or the hard disk drive is a non-volatile memory that stores various programs including an operating system or the like. The RAM functions as a work area of the processing executed by the processor 110, and temporarily stores the programs and the like stored in the flash memory and the like. It should be noted that a part (RAM) of the memory 120 may be built in the processor 110. The memory 120 stores table data D (FIGS. 8A and 8B) including the positional information acquired by the position measurement device 112 and the distance information (third distance information) acquired by the FMCW LiDAR F4 or the ToF LiDAR F5.

The display 130 displays an image in response to the control of the processor 110. Further, the display 130 is also used as a part of a graphical user interface (GUI) in a case in which various types of information are received from the operation unit 150.

The input/output interface 140 includes a connection unit that is connectable to an external device, a communication unit that is connectable to a network, and the like. The input/output interface 140 is connectable to the external device and the network in a wired or wireless manner. For example, the input/output interface 140 is connected to the position measurement device 112.

Here, the position measurement device 112 measures the positional information of the cart 3. Specifically, the position measurement device 112 measures the positional information of the cart 3 by measuring a moving distance of the cart 3 or measuring a moving speed and an elapsed time of the cart 3. For example, the cart 3 has a rotation speed measurement sensor on the wheel, and measures the moving distance or the moving speed of the cart 3 based on a rotation speed of the wheel obtained from the rotation speed measurement sensor. It should be noted that the acquisition of the positional information by the position measurement device 112 is not limited to the above-described example, and the positional information may be acquired by another method. For example, the position measurement device 112 may acquire the positional information by using a global positioning system (GPS).

The operation unit 150 includes a pointing device such as a mouse, a keyboard, and the like, and functions as a part of the GUI that receives various types of information and instructions input by a user operation.

### Laser Distance Measurement Method

Next, the laser distance measurement method using the laser distance measurement device 1 will be described.

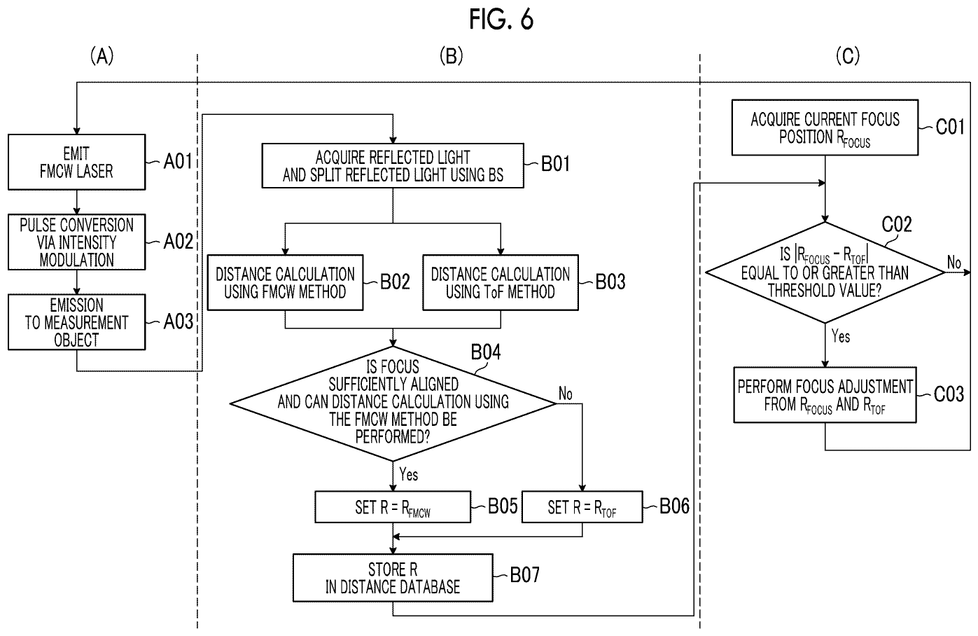

FIG. 6 is a flowchart showing the laser distance measurement method using the laser distance measurement device 1. It should be noted that the laser distance measurement method is performed by executing a dedicated program via the processor 110 of the laser distance measurement device 1.

A flowchart showing a laser irradiation step is shown in (A) of FIG. 6. A flowchart showing a distance information acquisition step is shown in (B) of FIG. 6. A flowchart showing a focus adjustment step is shown in (C) of FIG. 6.

The laser irradiation step shown in (A) of FIG. 6 will be described.

First, the laser irradiation control unit 110A causes the laser light source 21 to emit the first laser light PO (FMCW laser light) (step S_A01). Then, the first laser light PO is split into the first laser light for measurement PS and the laser light for reference PR by the first beam splitter 23. Then, the intensity modulator 25 modulates the intensity of the first laser light for measurement PS to perform the pulse conversion on the first laser light for measurement PS, and the intensity modulator 25 emits the pulsed second laser light for measurement PP (step S_A02). Then, the second laser light for measurement PP is emitted to the measurement object (wall surface T) through the second beam splitter 27, the third beam splitter 29, the focus adjustment mechanism 31, and the scanning unit 33 (step S_A03).

Next, the flowchart showing the distance information acquisition step shown in (B) of FIG. 6 will be described.

The scanning unit 33 acquires the second laser light for measurement (PP) reflected by the measurement object, and the acquired second measurement light (PP) is split by the third beam splitter 29 (in the drawing, denoted by BS) (step S_B01). The one split second measurement light (PP) is incident on the second beam splitter 27, is combined with the laser light for reference PR to form the interference light PA, and the beat signal PB is detected by the photodetector 37. The distance to the measurement object is calculated by the FMCW LiDAR processing unit 110B based on the detected beat signal PB (distance calculation using the FMCW method) (step S_B02). In addition, the other split second measurement light (PP) is incident on the photodetector 35 and detected, and thus the ToF LiDAR processing unit 110C calculates the time of flight of the round-trip of the second laser light for measurement PP (PP) to the measurement object (distance calculation in the ToF method) (step S_B03). Next, the distance information determination unit 110G determines whether or not the focus is sufficiently aligned and the distance calculation using the FMCW method can be performed (step S_B04). The distance information determination unit 110G can determine whether or not the focus is sufficiently aligned and the distance calculation using the FMCW method can be performed, by various methods. For example, the distance information determination unit 110G can determine whether or not the focus is sufficiently aligned and the distance calculation using the FMCW method can be performed, based on the height of the peak of the beat signal PB, the sharpness of the peak of the beat signal PB, or the width of the beat signal PB.

Hereinafter, an example will be described in which the distance information determination unit 110G performs the determination based on the height of the peak of the beat signal PB and an example will be described in which the distance information determination unit 110G performs the determination based on the sharpness of the peak of the beat signal PB.

First, an example will be described in which the distance information determination unit 110G performs the determination based on the height of the peak of the beat signal PB.

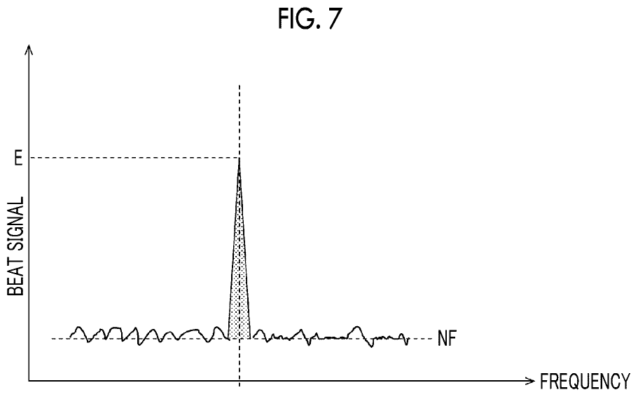

FIG. 7 is a diagram showing the beat signal PB detected by the photodetector 37. FIG. 7 shows a signal intensity of the beat signal PB on a vertical axis and a frequency on a horizontal axis, and shows the beat signal PB detected by the photodetector 37. Further, FIG. 7 shows a peak signal intensity E of the peak in the beat signal PB.

The distance information determination unit 110G can determine whether or not the focus is sufficiently aligned and the distance calculation using the FMCW method can be performed, based on whether or not the peak signal intensity E is equal to or greater than a threshold value SH1. In a case in which the peak signal intensity E is equal to or greater than the threshold value SH1, the distance information determination unit 110G determines that the focus is sufficiently aligned and the distance calculation using the FMCW method can be performed. On the other hand, in a case in which the peak signal intensity E is less than the threshold value SH1, the distance information determination unit 110G determines that the focus is not sufficiently aligned and the distance calculation using the FMCW method cannot be performed. It should be noted that the threshold value SHI is determined depending on the measurement environment, the intensity of the laser light source 21, and the like. In addition, the threshold value SHI is determined by adding an offset to noise floor NF.

Next, an example will be described in which the distance information determination unit 110G performs the determination based on the sharpness of the peak of the beat signal PB.

FIGS. 8A and 8B are diagrams showing the beat signal PB. FIGS. 8A and 8B show a signal intensity of the beat signal PB on a vertical axis and a frequency on a horizontal axis, and show the beat signal PB detected by the photodetector 37.

In FIG. 8A, a sharp peak is expressed in the beat signal PB. In a case in which such a peak is obtained in the beat signal PB, the distance information determination unit 110G determines that the focus is sufficiently aligned and the distance calculation can be performed by the FMCW LiDAR F4. In FIG. 8B, not sharp peak can be obtained in the beat signal PB. In a case in which such a sharp peak is not obtained in the beat signal PB, the distance information determination unit 110G determines that the distance calculation cannot be performed by the FMCW LiDAR F4. It should be noted that the known technology is applied to the method of measuring the sharpness of the beat signal PB.

Then, in a case in which the focus is sufficiently aligned and the distance can be calculated by the FMCW LiDAR F4, the distance information determination unit 110G determines the distance R_{FMCW} acquired by the FMCW LiDAR F4 as distance information R (third distance information) stored in the table data D (step S_B05). On the other hand, in a case in which the focus is not sufficiently aligned and the distance calculation using the FMCW method cannot be performed, the distance information determination unit 110G determines a distance R_{TOF} acquired by the ToF LiDAR F5 as the distance information R to be stored in the table data D (step S_B06). Thereafter, the distance information R is stored in the table data D by the table data update unit 110D (step S_B07).

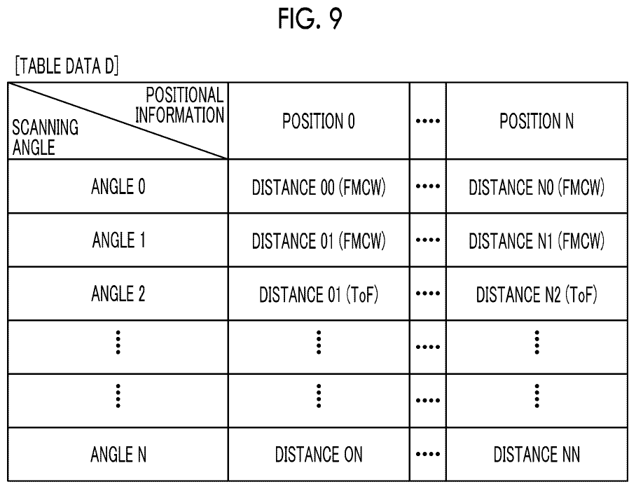

FIG. 9 is a diagram showing a storage configuration example of the table data D.

As shown in FIG. 9, in the table data D, the distance information R is stored in association with the scanning angle of the scanning unit 33 and the positional information of the cart 3. Further, in the table data D, the distance information R is stored in association with whether the distance information R is the distance R_{FMCW} acquired by the FMCW method or the distance R_{TOF} acquired by the ToF method. For example, in a case in which the scanning angle is an angle 1, the distance R_{FMCW} acquired by the FMCW method is stored as the distance information R from a position 0 to a position N. On the other hand, in a case in which the scanning angle is an angle 2, the distances R_{TOF} acquired by the ToF method is stored as the distance information R from the position 0 to the position N. The three-dimensional shape data of the wall surface T can be obtained based on the distance to each measurement point stored in the table data D.

Returning to FIG. 6, the flowchart showing the focus adjustment step shown in (C) of FIG. 6 will be described.

A current focus position R_{FOCUS} is acquired by the focus control unit 110F (step S_C01). For example, the focus control unit 110F acquires the focus position R_{FOCUS} from the current position of the focus lens in the focus adjustment mechanism 31. Then, the focus control unit 110F determines whether or not the focus position R_{FOCUS} is aligned with the measurement object (step S_C02). Specifically, the focus control unit 110F determines whether or not the focus position R_{FOCUS} is aligned with the measurement object, by determining whether or not an absolute value of R_{FOCUS}-R_{TOF} is equal to or greater than a threshold value SH2. In a case in which the absolute value of R_{FOCUS}-R_{TOF} is equal to or greater than the threshold value SH2, the focus control unit 110F adjusts the focus position based on R_{FOCUS} and R_{TOF} (step S_C03). On the other hand, in a case in which the absolute value of R_{FOCUS}-R_{TOF} is less than the threshold value SH2, the focus control unit 110F emits the FMCW laser to perform the measurement at the next measurement point while maintaining the current focus position R_{FOCUS}. It should be noted that the threshold value SH2 is determined based on conditions such as a surface state of the measurement object, a measurement distance, and the accuracy of the focus adjustment mechanism 31.

As described above, with the laser distance measurement method using the laser distance measurement device 1, the distance is measured by the FMCW LiDAR F4 having relatively high accuracy and the ToF LiDAR F5 that is relatively robust to the distance change using the measurement light emitted from the same laser light source 21, so that it is possible to perform measurement that has high measurement accuracy and that is robust to the change in the distance to the measurement object, by using the miniaturized device.

### Others

In the above-described embodiment, the hardware structures of processing units (laser irradiation control unit 110A, FMCW LiDAR processing unit 110B, ToF LiDAR processing unit 110C, table data update unit 110D, table data reference unit 110E, focus control unit 110F, and distance information determination unit 110G) that execute various types of processing are various processors as described below. The various processors include a central processing unit (CPU), which is a general-purpose processor that executes software (program) and functions as the various processing units, a programmable logic device (PLD), which is a processor of which a circuit configuration can be changed after manufacture, such as a field programmable gate array (FPGA), and a dedicated electric circuit, which is a processor of which a circuit configuration is designed for exclusive use in order to execute specific processing, such as an application specific integrated circuit (ASIC).

One processing unit may be configured by one of these various processors, or may be configured by two or more processors of the same type or different types (for example, a plurality of FPGAs, or a combination of a CPU and an FPGA). Moreover, a plurality of processing units may be configured by one processor. As a first example the configuration of the plurality of processing units by one processor, there is a form in which one processor is configured by combining one or more CPUs and software, and this processor functions as the plurality of processing units, as represented by a computer, such as a client or a server. Second, there is a form in which a processor, which achieves the functions of the entire system including the plurality of processing units with one integrated circuit (IC) chip, is used, as represented by a system on chip (SoC) or the like. In this manner, various processing units are configured by one or more of the various processors described above, as the hardware structure.

Furthermore, the hardware structure of these various processors is, more specifically, an electric circuit (circuitry) in which circuit elements, such as semiconductor elements, are combined.

Each of the configurations and the functions described above can be implemented as appropriate by any hardware, software, or a combination thereof. For example, the present invention can be applied to a program causing a computer to execute the above-described processing steps (processing procedures), a computer-readable recording medium (non-transitory recording medium) on which such a program is recorded, or a computer in which such a program can be installed.

### Supplementary Note

The contents disclosed above include, for example, the contents of the following invention.

### (Aspect 1)

A laser distance measurement device comprising: a laser light source that emits first laser light of a frequency-modulated continuous wave (FMCW) mode; an intensity modulator that periodically modulates an intensity of the first laser light to generate pulsed second laser light; a first distance measurement instrument that generates an interference light by incidence of first measurement light obtained from the second laser light and first reference light obtained from the first laser light, that detects a beat frequency included in the interference light, and that acquires first distance information to a measurement object based on the beat frequency; and a second distance measurement instrument that measures a round-trip time of a pulse component included in the first measurement light to the measurement object based on information regarding an emission timing of the second laser light from the intensity modulator and the pulse component, and that acquires second distance information to the measurement object based on the round-trip time.

### (Aspect 2)

The laser distance measurement device according to aspect 1, further comprising: a processor configured to, in a case in which the first distance information and the second distance information are acquired, determine the first distance information as third distance information to be output.

### (Aspect 3)

The laser distance measurement device according to aspect 2, in which the processor is configured to, in a case in which the first distance information and the second distance information are acquired, store the first distance information in a memory as the third distance information.

### (Aspect 4)

The laser distance measurement device according to any one of aspects 1 to 3, further comprising: a beam splitter that splits the first reference light from the first laser light.

### (Aspect 5)

The laser distance measurement device according to any one of aspects 1 to 4, further comprising: a beam splitter that splits the first measurement light reflected by the measurement object into second measurement light and third measurement light, in which the second measurement light is incident on the first distance measurement instrument, and the third measurement light is incident on the second distance measurement instrument.

### (Aspect 6)

The laser distance measurement device according to any one of aspects 1 to 5, further comprising: a focus adjustment mechanism that adjusts a focus position of the first measurement light and that focuses the first measurement light on a surface of the measurement object; and a processor configured to control the focus adjustment mechanism based on the second distance information.

### (Aspect 7)

The laser distance measurement device according to any one of aspects 1 to 6, in which the intensity modulator is configured as an acousto-optic element, an LN modulator, or an optical switch.

### (Aspect 8)

The laser distance measurement device according to any one of aspects 1 to 7, in which the information regarding the emission timing is information regarding an emission timing of the pulse component of the second laser light.

### (Aspect 9)

A laser distance measurement method comprising: a step of, via a laser light source, emitting first laser light of a frequency-modulated continuous wave (FMCW) mode; a step of, via an intensity modulator, periodically modulating an intensity of the first laser light to generate pulsed second laser light; a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.

### (Aspect 10)

A program causing a computer to execute: a step of, via a laser light source, emitting first laser light of a frequency-modulated continuous wave (FMCW) mode; a step of, via an intensity modulator, periodically modulating an intensity of the first laser light to generate pulsed second laser light; a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.

The examples of the present invention have been described above, but it goes without saying that the present invention is not limited to the above-described embodiments, and various modifications can be made without departing from the gist of the present invention.

### Explanation of References

1: laser distance measurement device
2: angle
3: cart
5: measurement head
9: control device
11: inspection apparatus
13: railroad
15: scanning line
21: laser light source
23: first beam splitter
25: intensity modulator
27: second beam splitter
29: third beam splitter
31: focus adjustment mechanism
33: scanning unit
35: photodetector
37: photodetector
41: reference mirror
43: reference mirror
110: processor

What is claimed is:

1. A laser distance measurement device comprising:
a laser light source that emits first laser light of a frequency-modulated continuous wave (FMCW) mode;
an intensity modulator that periodically modulates an intensity of the first laser light to generate pulsed second laser light;
a first distance measurement instrument that generates an interference light by incidence of first measurement light obtained from the second laser light and first reference light obtained from the first laser light, that detects a beat frequency included in the interference light, and that acquires first distance information to a measurement object based on the beat frequency; and
a second distance measurement instrument that measures a round-trip time of a pulse component included in the first measurement light to the measurement object based on information regarding an emission timing of the second laser light from the intensity modulator and the pulse component, and that acquires second distance information to the measurement object based on the round-trip time.

2. The laser distance measurement device according to claim 1, further comprising:
a processor configured to, in a case in which the first distance information and the second distance information are acquired, determine the first distance information as third distance information to be output.

3. The laser distance measurement device according to claim 2,
wherein the processor is configured to, in a case in which the first distance information and the second distance information are acquired, store the first distance information in a memory as the third distance information.

4. The laser distance measurement device according to claim 1, further comprising:
a beam splitter that splits the first reference light from the first laser light.

5. The laser distance measurement device according to claim 1, further comprising:
a beam splitter that splits the first measurement light reflected by the measurement object into second measurement light and third measurement light,
wherein the second measurement light is incident on the first distance measurement instrument, and the third measurement light is incident on the second distance measurement instrument.

6. The laser distance measurement device according to claim 1, further comprising:
a focus adjustment mechanism that adjusts a focus position of the first measurement light and that focuses the first measurement light on a surface of the measurement object; and
a processor configured to control the focus adjustment mechanism based on the second distance information.

7. The laser distance measurement device according to claim 1,
wherein the intensity modulator is configured as an acousto-optic element, an LN modulator, or an optical switch.

8. The laser distance measurement device according to claim 1,
wherein the information regarding the emission timing is information regarding an emission timing of the pulse component of the second laser light.

9. A laser distance measurement method comprising:
a step of, via a laser light source, emitting first laser light of a frequency-modulated continuous wave (FMCW) mode;
a step of, via an intensity modulator, periodically modulating an intensity of the first laser light to generate pulsed second laser light;
a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and
a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.

10. A non-transitory, computer-readable tangible recording medium on which a program for causing a computer to execute:
a step of, via a laser light source, emitting first laser light of a frequency-modulated continuous wave (FMCW) mode;
a step of, via an intensity modulator, periodically modulating an intensity of the first laser light to generate pulsed second laser light;
a step of, via a first distance measurement instrument, generating an interference light by incidence of first measurement light obtained from the second laser light and first reference light obtained from the first laser light, detecting a beat frequency included in the interference light, and acquiring first distance information to a measurement object based on the beat frequency; and
a step of, via a second distance measurement instrument, measuring a round-trip time of a pulse component included in the first measurement light to the measurement object based on information regarding an emission timing of the second laser light from the intensity modulator and the pulse component, and acquiring second distance information to the measurement object based on the round-trip time.
